(19) United States
(12) Patent Application Publication
(10) Pub. No.: US 2015/0379169 A1
(43) Pub. Date: Dec. 31, 2015

(54) EFFICIENT EMULATION FOR PSEUDO-WRAPPED CALLBACK HANDLING IN BINARY TRANSLATION SOFTWARE

(71) Applicants: YONG WU, Shanghai (CN); XIAO DONG LIN, Shanghai (CN); YIHUA JIN, Shanghai (CN)

(72) Inventors: YONG WU, Shanghai (CN); XIAO DONG LIN, Shanghai (CN); YIHUA JIN, Shanghai (CN)

(21) Appl. No.: 14/318,558

(22) Filed: Jun. 27, 2014

(51) Int. Cl. G06F 17/50; G06F 9/455

(52) U.S. Cl. CPC G06F 17/5009; G06F 9/45558; G06F 2009/45575

(57) ABSTRACT

Systems and methods may provide efficient emulation for pseudo-wrapped callback (PWC) handling in binary translation software. The systems and methods may provide a process virtual machine (PVM) that includes an ISA emulator and PVM runtime configured to identify a target ISA wrapper (TW) as a unique representation of the target ISA code (TB), install an additional translation index entry that directly maps an Instruction Pointer (IP) for TW to a translation of a source ISA code B (SB). The PVM may also an emulation “fast path” that allows the emulation to bypass the trapping of TW and jump to SB's emulation without breaking the emulation flow (e.g., in instances where SB's translation is already available). The PVM may thereby improve performance by removing the context switch from the executor to the PVM runtime for PWC callback emulation.

### BACKGROUND

A computing device may be characterized by its Instruction Set Architecture (ISA). Typically, a computing device may include Operating System (OS) services, and the OS services may include runtime library services (LIB), developed for the ISA of the computing device, to facilitate the development of applications to operate on the computing device. For example, various smartphones may be characterized by the use of the ARM (ARM Holdings) processor and its ISA. These smartphones may include an OS, e.g., IOS (Apple, Inc.) or ANDROID (Open Handset Alliance), in support of the various applications developed for the respective smartphones. Some computing devices offer an ISA-independent execution environment, such as JAVA (Sun Microsystems, Inc.) or ANDROID Application Framework. A large number of applications, however, may nonetheless include ISA-dependent portions that invoke the services of ISA-dependent runtime libraries. Further, these ISA-dependent portions often include callback functions requiring execution (e.g., “callbacks”) from the ISA-dependent runtime libraries, and such callbacks are often not discovered until runtime, rendering traditional approaches, such as binary translation, inadequate in addressing the needs of the callback functions. Additionally, these ISA-dependent portions may also include overriding implementations of inheritable virtual functions of the ISA-dependent runtime libraries that need to be properly called when the virtual functions are called. The traditional approaches, such as binary translation, may likewise be inadequate in addressing the needs of the virtual functions.

Further, a process virtual machine (PVM) may be used to allow an application compiled for a source ISA and LIB to run on a target ISA and LIB. This approach may include function calls from a source LIB to a target LIB, and on the reverse direction, function calls from the target LIB to the source LIB, (i.e., callback). In order to handle the callback function, the PVM may create a “wrapper” to that callback function. When the wrapper function is in the target ISA, it may, for example, transfer the control to a “trampoline” to convert the ABI (application binary interface) from the target ISA function to the source ISA function, and it may further execute the source function in the PVM.

The wrapped callback functions (in the source LIB) may at the same time be called by other source functions. This may lead to a special callback with the control flow referred hereto herein as “pseudo-wrapped callback” (PWC, i.e., source function to callback wrapper to source function). In a PWC, the PVM may identify the PWC callback wrapper during the emulation of source to source call because the wrapper is the target ISA (which may break the source ISA's original control flow). Thus, the PVM may fail to perform a translation lookup when it meets the callback wrapper using the address of the callback wrapper address as the index to lookup. This failure may cause the PVM to provide a “slow path” for emulation by switching between different emulation modes/contexts to deliver the control transferring. The switching process may lead to significant inefficiency due to substantial overhead of control transferring in PWC handling.

### BRIEF DESCRIPTION OF THE DRAWINGS

The various novel aspects of the embodiments of the present disclosure will become evident to a person of ordinary skill in the art given the following enabling specification and appended claims, and by referencing the following drawings, in which:

FIG. 1 is an illustration of an example computing device incorporating a PVM with callback and virtual function support according to an embodiment;

FIG. 2 is an illustration of an example of the PVM of FIG. 1 according to an embodiment;

FIG. 3 is an illustration of an example of an emulated execution flow of a normal function call according to an embodiment;

FIG. 4 is an illustration of an example of an emulated execution flow of a PWC callback function according to an embodiment;

FIG. 5 is an illustration of an example of an optimized emulated execution flow of a PWC callback function according to an embodiment; and

FIG. 6 is a flowchart of an example of a method of optimizing an emulated execution flow of a PWC callback function according to an embodiment.

### DETAILED DESCRIPTION OF THE DRAWINGS

Methods, apparatuses and storage media associated with Instruction Set Architecture (ISA) bridging with callback and virtual function support are disclosed. In various embodiments, at least one computer-readable storage medium may include instructions configured to enable a target device with a target ISA, in response to execution of the instructions. Such an approach may provide a process virtual machine (PVM) to the target device to facilitate a library service of a library of the target device to call a virtual function of the library, while servicing an application. The library service may be implemented for the target ISA, and the application may be implemented at least partially for a source ISA that may be different from the target ISA, wherein the application includes a class with an overriding implementation of the virtual function. The PVM may include a loader configured to load the application for execution, and as part of the loading, detect the virtual function, and modify a virtual function table of the application to enable, in response to the call, execution control to be transferred from the target ISA to the overriding implementation of the virtual function implemented in source ISA instructions. The PVM, in some embodiments, may further include an ISA emulator and a PVM runtime configured to cooperate with one another and enable the execution control transfer, in response to the call, as well as the application to call the library service, and the library service to callback the callback function, across the ISAs.

The PVM, in at least some embodiments, may be configured to wrapper the overriding implementation of the virtual function, or callback function, implemented in source ISA instructions, with a target ISA wrapper, to facilitate the target to source ISA transferring.

In at least some embodiments, the ISA emulator and PVM runtime may be configured to identify a target ISA wrapper (TW) as a unique representation of the source ISA code B (SB), install an additional translation index entry that directly maps an Instruction Pointer (IP) for TW to a translation of a source ISA code B (SB, i.e., the target ISA code B (TB)).

In at least some embodiments, the PVM provides an emulation “fast path” that allows the emulation to bypass the trapping of TW and jump to SB's emulation without breaking the emulation flow (e.g., in instances where SB's translation is already available). The PVM may therefore improve performance by removing the context switch from the executor to the PVM runtime for PWC callback emulation.

Various aspects of the illustrative embodiments will be described using terms commonly employed by those skilled in the art to convey the substance of their work to others skilled in the art. However, it will be apparent to those skilled in the art that alternate embodiments may be practiced with only some of the described aspects. For purposes of explanation, specific numbers, materials, and configurations are set forth in order to provide a thorough understanding of the illustrated embodiments. However, it will be apparent to one skilled in the art that alternate embodiments may be practiced without the specific details. In other instances, well-known features are omitted or simplified in order not to obscure the illustrative embodiments.

Various operations will be described as multiple discrete operations, in turn, in a manner that is most helpful in understanding the illustrative embodiments; however, the order of description should not be construed as to imply that these operations are necessarily order dependent. In particular, these operations need not be performed in the order of presentation. Further, descriptions of operations as separate operations should not be construed as requiring that the operations be necessarily performed independently and/or by separate entities. Descriptions of entities and/or modules as separate modules should likewise not be construed as requiring that the modules be separate and/or perform separate operations. In various embodiments, illustrated and/or described operations, entities, data, and/or modules may be merged, broken into further sub-parts, and/or omitted.

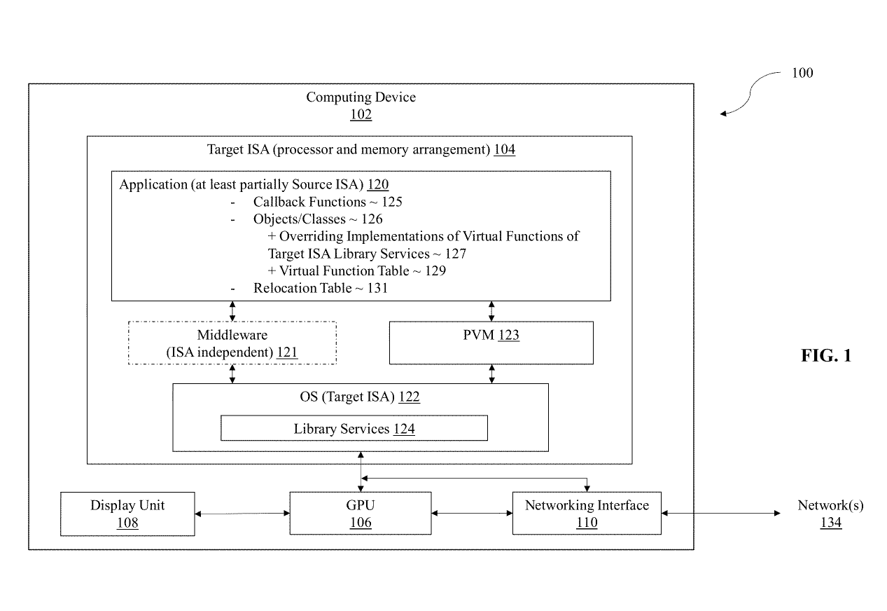

FIG. 1 illustrates an example system 100 having computing device incorporated with a Process Virtual Machine (PVM) having callback and virtual function support, in accordance with various embodiments of the present disclosure. As shown, for the illustrated embodiments, the system 100 may include a computing device 102 having a processor and memory arrangement 104 configured to have an operating system (OS) 122, PVM 123, and application 120 operated therein, and a graphics processing unit (GPU) 106, display unit 108, and networking interface 110, coupled with each other as shown. The OS 122 may include a library of services 124. Additionally, computing device 102 may also include optional middleware 121 between application 120 and OS 122. As will be described in more detail below, PVM 123 may be configured with various application load and runtime features or services (including, but are not limited to, e.g., dynamic binding) to enable application 120 to be implemented in a source ISA in whole or in part (e.g., when an ISA-independent middleware 121 is also used), while OS 122 (including library services 124) may be implemented in a target ISA that is different from the source ISA. Further, application 120 may be an application (in particular, the portion implemented using source ISA) that includes usage characteristics of library services 124 that require various ones of library services 124 to callback various callback functions 125 of application 120, under various conditions.

In embodiments, application 120 may be object oriented or include classes 126. For these embodiments, application 120 may include objects/classes 126 with one or more overriding implementations of virtual functions 127 inherited from target ISA library services 124. Additionally, application 120 may include one or more virtual function tables 129 for storing these overriding implementations of the virtual functions 127 inherited from the target ISA library services 124 (hereinafter, simply overriding implementations 127). The one or more virtual function tables 129 may further include associated metadata describing the overriding implementations 127. In some embodiments, application 120 may further include a relocation table 131 containing symbol names and other information that facilitate runtime resolution of the portions unresolved at compile time.

In various embodiments, PVM 123 may include support for execution control to be properly transferred across the different ISA to these overriding implementations 127 when various ones of library services 124 call the virtual function. In at least some embodiments, PVM 123 may include support for PVM runtime execution to map an IP for TW directly to a translation for SB (TB). The PVM 123 may thereby improve performance by removing the context switch from an executor to a PVM runtime for PWC callback emulation. Various embodiments of PVM 123 will be further described below.

The computing device 102 may be a server, a desktop computer, a laptop computer, a tablet computer, a smartphone, a personal digital assistant, a game console, an Internet appliance, or other computing devices of the like. Examples of computing device 102 may include, but are not limited to, servers available from Hewlett Packard of Palo Alto, Calif., desktop or laptop computers available from Dell Computer of Austin, Tex., smartphones and computing tablets available from Apple Computer of Cupertino, Calif., game consoles available from Nintendo Corporation of Tokyo, Japan, and so forth.

The processor and memory arrangement 104 is intended to represent a broad range of processor and memory arrangements including, but not limited to, arrangements with single or multi-core processors of various execution speeds and power consumptions, and memory of various architectures with one or more levels of caches, and of various types, such as dynamic random access, flash, and so forth. In various embodiments, GPU 106 may be configured to provide video decoding and/or graphics processing functions to OS 122, while display unit 108 may be configured to enable multi-media content, e.g., HD video, to be rendered thereon. Similarly, GPU 106 and display unit 108 are intended to represent a broad range of graphics processors and display elements known in the art. Likewise, network(s) 134 is (are) intended to represent a broad range of networks known in the art. Examples of network(s) 134 may include wired or wireless, local or wide area, private or public networks, including the Internet.

The OS 122 (including library services 124), except for the application programming interface (API) defining invocation of library service 124, is intended to represent a broad range of operating system elements known in the art. OS 122 may include conventional components such as a kernel configured to manage memory resources, schedule task execution, and so forth, and device drivers configured to manage various device resources. In embodiments, OS 122 may include a virtual machine in support of middleware 121 (if employed), e.g., a virtual machine in support of the ANDROID Application Framework. For the embodiments, in addition to defining invocations of library services 124, to facilitate invocation of callback functions 125 of application 120, the API of library services 124 may also include the corresponding stubs and signatures of callback functions 125 of application 120. Examples of the OS 122 may include, but are not limited to, WINDOWS operating systems, available from Microsoft Corporation of Redmond, Wash., LIMA operating systems, available from, e.g., RED HAT of Raleigh, N.C., ANDROID operating systems developed by the Open Handset Alliance, or IOS, available from APPLE Computer of Cupertino, Calif.

Similarly, middleware 121 is intended to represent a broad range of middleware elements known in the art including, but not limited to, ISA-independent middleware. Examples of middleware 121 may include, but are not limited to, ANDROID Application Framework, JAVA, or other application frameworks or ISA-independent execution environments.

Likewise, application 120 (including callback functions 125, overriding implementations 127, etc) is intended to represent a broad range of applications known in the art. Examples of application 120 may include, but are not limited to, personal assistant, productivity or social networking applications, such as, for example, calendar, word processing, spreadsheet, TWITTER, FACEBOOK, et at, or generic application agents, such as a browser. Examples of a browser may include, but are not limited to, INTERNET EXPLORER, available from Microsoft Corporation of Redmond, Wash., or FIREFOX, available from Mozilla of Mountain View, Calif.

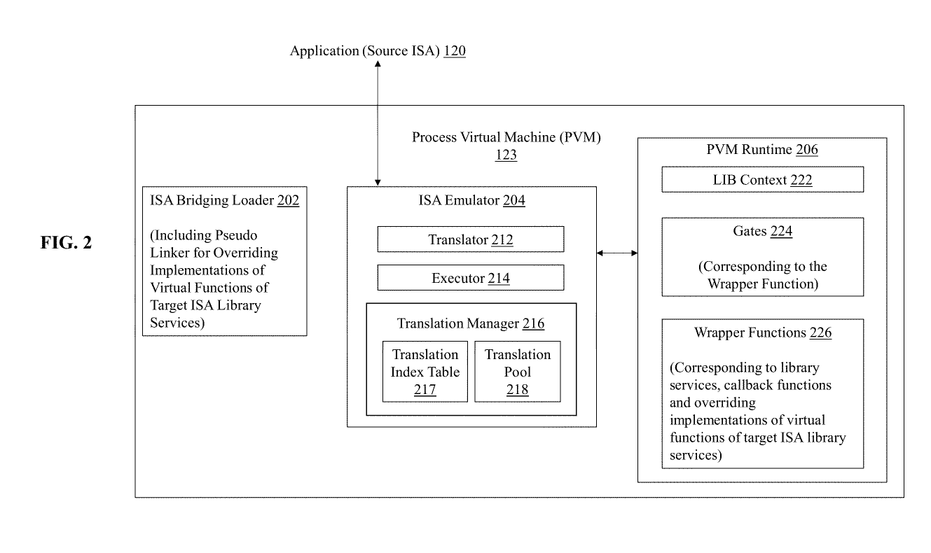

Referring now to FIG. 2, wherein illustrated is an example PVM 123, in accordance with various embodiments of the present disclosure. As shown, for the embodiments, the PVM 123 may include an ISA bridging loader 202, an ISA emulator 204 (e.g., source ISA emulator) and a PVM runtime 206 (e.g., ISA Library (LIB) emulator), configured to provide various runtime features and services including, but not limited to, dynamic binding services. The ISA emulator 204 may include a translator 212, an executor 214, and a translation manager 216. The translator 212 may translate source ISA instructions into target ISA instructions. The translation manager 216 may also include and maintain a translation index table 217 and a translation pool 218 in order to facilitate execution of the translations, Each translation in the translation pool 218 may be indexed in the translations index table 217 by its entry address. The executor 214 may provide a translation lookup mechanism in the PVM 123. The executor 214 may, for example, follow an execution flow of applications by retrieving and executing a translation with a given IP address to perform a translation lookup. If, however, there is no translation associated with the given IP, the executor 214 may trigger the translator 212 to generate a new translation for the given IP.

The ISA emulator 204 may maintain, in translator 212, the execution context of source ISA architecture including, but not limited to, e.g., the current execution instruction pointer (IP). The translator 212 may be configured to translate source ISA instructions to target ISA instructions. The PVM runtime 206 may include target ISA Library (LIB) context 222, gates 224 and wrapper functions 226. The PVM runtime 206 may maintain in target ISA Library (LIB) context 222, the execution context of target ISA Library, With continuing reference to FIGS. 1 and 2, in various embodiments, there may also be one corresponding pair of gate 224 and wrapper function 226 per library service 124, configured to facilitate calling of library service 124 by application 120, across the source and target ISA architectures. Similarly, there may be one corresponding pair of gate 224 and wrapper function 226 per callback function 125 and per overriding implementations 127, configured to facilitate callback of callback function 125 by library services 124, across the target and source ISA architectures, and transfer of execution control to the overriding implementations 127, across the target and source ISA architectures, when the virtual functions are called.

The ISA bridging loader 202 may be configured to load the application 120. In loading the application 120, the ISA bridging loader 202 may be configured to resolve any unresolved symbolic names of application 120 associated with calling library services to appropriate ones of the library services 124. In some embodiments, the ISA bridging loader 202 may be configured to resolve any unresolved symbolic names of application 120 associated with calling library services to addresses of the corresponding gates 224 of library services 124. ISA bridging loader 202 may also be configured to modify the symbolic names or references to callback functions 125 to internal names, and associate the symbolic names or references to callback functions 125 to the corresponding wrapper functions 226.

Further, the ISA bridging loader 202 may further include pseudo linker functions configured to resolve various overriding implementations 127 when loading application 120 for execution. In some embodiments, the ISA bridging loader 202 as part of the loading may identify overriding implementations 127, using information in the relocation table 131. The ISA bridging loader 202, in some embodiments, may be further configured to enable execution control to be transferred across the ISA to overriding implementations 127, if appropriate, when the library services 124 call the virtual functions, by modifying the virtual function tables 129, replacing entries in the virtual function tables 129 with corresponding wrapper functions. In some embodiments, the wrapper functions may include pointers to the overriding implementations 127.

The ISA bridging loader 202 may gain control of the loading from the loader of the OS 122 (or middleware 121, if employed) in any one of a number of known manners. Examples of such known manners may include the use of binary format based control transfer or load/pre-load variables when supported by OS 122 or middleware 121. In other embodiments, the loader of the OS 122 (or middleware 121, if employed) may be modified to facilitate the transfer of control to ISA bridging loader 202 instead.

As described earlier, the ISA emulator 204 may be configured to maintain translator 212. The ISA emulator 204 may be configured to track the source ISA IP during execution of application 120. When application 120 attempts to invoke a library service 124, the ISA emulator 204 monitoring the execution of the source ISA 120 may instead invoke and transfer execution control to the PVM runtime 206. In various embodiments, the ISA emulator 204 may also invoke and transfer execution control to the corresponding gate 224 of the library service 124.

The PVM runtime 206 may likewise be configured to maintain the target ISA library (LIB) execution context 222. The gates 224 corresponding to the library services 124 may be configured to respectively redirect calls to the library services 124 to the corresponding wrapper functions 226 to process and set up the calls. The gates 224 corresponding to the callback functions 125 or the overriding implementations 127, on the other hand, may be configured to respectively transfer execution control for callbacks or calls to the virtual functions, from the corresponding wrapper functions 226 to the ISA emulator 204. In various embodiments, each gate 224 may include an instruction configured to effectuate the redirect to the corresponding wrapper function 226 or the emulator 204. In at least some embodiments, the instruction of each gate 224 may be a source ISA instruction configured to cooperate with the executor 214 to effectuate execution control redirection. In at least some embodiments, each gate 224 may further include an indicator identifying the corresponding wrapper function 226.

In various embodiments, for processing and setting up a call to the corresponding library service 124, each wrapper function 226 corresponding to a library service 124 may be configured to retrieve the associated parameter values of the call from the translator 212, convert the call from the source ISA application binary interface (ABI) format to the target ISA ABI format, and save the converted call with the parameter values in the LIB context 222.

On a callback to a callback function 125, or a call to an overridden virtual function, execution control may be transferred to the corresponding wrapper function 226 of the callback function 125 or the overriding implementations 127. In various embodiments, for processing and setting up a callback to a callback function 125 or transfer of execution control to the overriding implementation 127 of the application 120, each wrapper function 226 corresponding to a callback function 125 or an overriding implementation 127 may be configured to convert the callback or call to the overridden virtual function from the target ISA ABI format to the source ISA ABI format, attach the associated parameter values of the callback or call to the overridden virtual function, and save the converted callback or call to the overridden virtual function with the parameter values in the translator 212.

The gates 224 corresponding to a callback function 125 or an overriding implementation 127 may be configured to invoke the ISA emulator 204 with the translator 214 prepared by the wrapper function 226 corresponding to the callback function 125 or the overriding implementation 127 to emulate the callback function 125 or the overriding implementation 127 presented in source ISA format on target ISA.

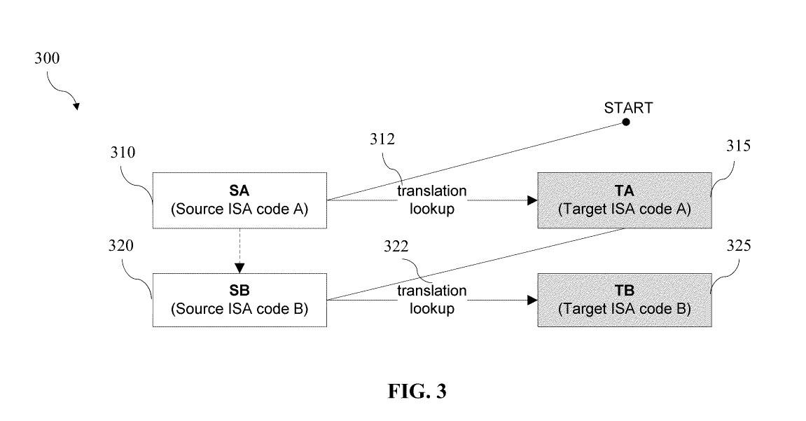

FIGS. 3-5 generally illustrate examples of emulated execution flows for PWC callback according to embodiments of the disclosure. More particularly, FIG. 3 illustrates an emulated execution flow 300 for a normal function call (i.e., having no callback). The emulated execution flow 300 depicts an emulation for a normal function call from the source ISA code A (SA) 310 to the source ISA code B (SB) 320. The target ISA code A (TA) 315 provides a translated target code of SA 310 and target ISA code B (TB) 325 provides a translated target code of SB 320. The translated codes TA 315 and 325 of source codes SA 310 and 320, respectively. The translated codes TA 315 and TB 325 are generated by corresponding translation lookups 312 and 322, respectively, and provide two possible channels from TA 315 to TB 325.

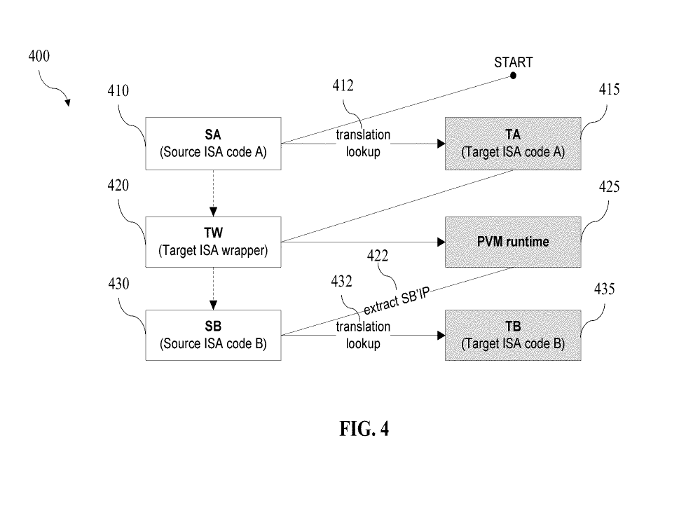

FIG. 4 illustrates an example of an emulated execution flow 400 for a PWC callback function call. The emulated execution flow 400 depicts an emulation for a PWC callback function call from the source ISA code A (SA) 410 to the source ISA code B (SB) 430. The target ISA code A (TA) 415 provides a translated target code of SA 410 via the translation lookup 412. The target ISA code B (TB) 435 provides a translated target ISA code of SB 430 via the translation lookup 432. The PVM runtime 425 extracts the IP 422 for SB from the target ISA wrapper (TW) via, e.g., a lookup table. As shown in FIG. 4, the trap to the PVM runtime 425 and any associated context switches (not shown here) may be unavoidable. The PWC function, in this instance, may be referred to being performed via a “slow path”.

The general pattern of the control flow for PWC callback may be source code A (SA) to target wrapper code (TW) to source code B (SB), and may be referred to as a “slow path”. The PWC callback function, in a “slow path”, may typically include breaking SA's emulation and trapping into TW, and extracting SB's address from TW and restarting SB's emulation. Referring to FIG. 4, for example, when the executor executes to an instruction that invokes a TW in a target ISA (e.g., TW 420 via TA 415), control may be transferred to the PVM runtime 425 which may extract the IP of SB 430 from the TW 420 (e.g., by reading certain place in TW 420 to get the IP address of SB 430). The translation index table 432 may then be checked to get the translation entry for SB 430 (i.e., TB 435) and restart the execution with TB 435. This callback emulation process may incur translation overhead on context switches and may, therefore, provide a non-optimized or “slow path” for PWC callback emulation. Further, because the IP of SB is not presented from SA, the callback emulation process provides no opportunity for chaining which links TA with TB directly (e.g., with a jump instruction).

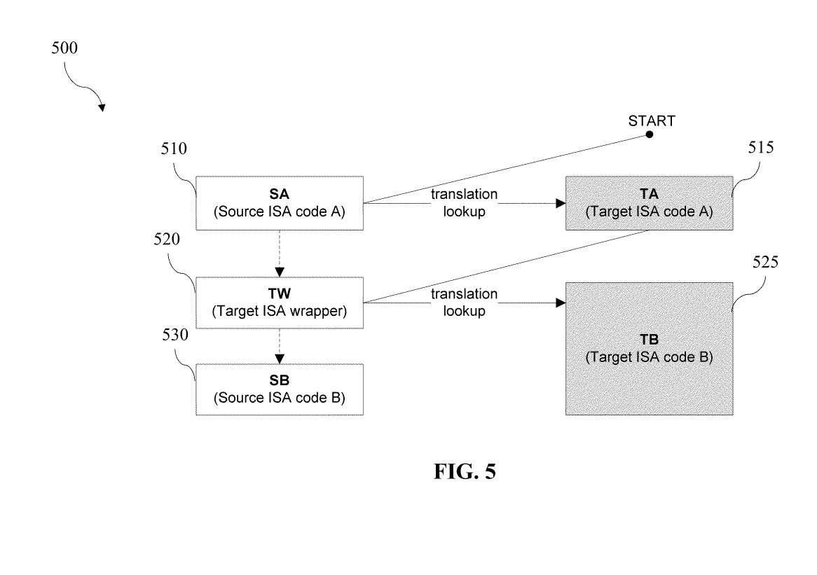

FIG. 5 illustrates an example of an optimized emulated execution flow of a PWC callback function according to an embodiment of the present disclosure. The “fast path” may allow the optimized emulation execution flow 500 to bypass the trapping of TW and jump to SB's emulation without breaking the emulation flow in case of SB's translation is already available. The optimized emulated execution flow 500 depicts an emulation for a PWC callback function call from the source ISA code A (SA) 510 to the source ISA code B (SB) 530. The target ISA code A (TA) 515 provides a translated target code of SA 510 via translation lookup 512. The target ISA code B (TB) 525 provides a translated target ISA code of the target ISA code B (SB) 530. The target ISA wrapper (TW) 520 may be identified as a unique representation of the source ISA code B (SB) 530. An additional translation index entry, e.g., translation lookup 522, may be installed to directly map an IP for TW 520 to a translation of source ISA code B (SB) 530, i.e., the target ISA code B (TB) 525.

Referring again to FIG. 2 in conjunction with FIG. 5, the optimized emulated execution flow 500 may remove the context switch from the executor 214 to the PVM runtime 206 to provide a “fast path” for PWC callback emulation. In at least some embodiments, the ISA emulator 204 and the PVM runtime 206 may be configured to identify a target ISA wrapper (TW) (e.g., TW 520) as a unique representation of the target ISA code (TB) (e.g., TB 525), install an additional translation index entry (e.g., translation lookup 522) that directly maps an Instruction Pointer (IP) for TW to a translation of a source ISA code B (SB). In at least some embodiments, the PVM 123 provides an emulation “fast path” to bypass the trapping of TW and jump to SB's emulation without breaking the emulation flow (e.g., in instances where SB's translation is already available). The PVM 123 may thereby improve efficiency by removing the context switch from the executor 214 to the PVM runtime 206 for PWC callback emulation.

The first time that a source ISA code B (SB) (e.g., SB 530) is emulated (i.e., when the executor 212 reaches an IP with SB), TB has not been generated and the translation index table 217 for SB has not been constructed (i.e., TB has not been generated by the translator and there is no mapping from SB to TB in the translation index). In this circumstance, the translator is invoked to generate the translation entry for the target ISA code B (TB) (e.g., TB 525) in the translation pool 218 and insert the SB to TB mapping into the translation index table 217 (i.e., the translation execution for SB to TB is mapped and stored). This process allows the executor 214 to jump to TB by translation lookup (e.g., translation lookup 522) if the address for SB is emulated without the need to perform the translation again (i.e., generate the TB from SB). Knowing that TW (e.g., TW 520) is a unique identifier of SB (e.g., 530), during the “slow path” where PVM extracts the unique SB from TW, and finds the TB from the translation index table, an additional entry of mapping may be installed in the translation index table 217 from TW to TB. Thus, in addition to SB, TW may be used to index TB as well. TW and SB have a 1:1 mapping (i.e., one TW is created by the PVM for one and only one SB). When SB is later emulated, if the translation for SB (TB) has already been generated, when the executor 212 reaches IP with TW, it queries the translation manager 216 and gets a corresponding translation TB. The executor 212 may then execute TB, which emulates SB. This approach may allow the overhead of the executor context switch to be removed and executor 214 may continue running across TW via the translation manager 216 without breaking the original control flow. Therefore, for PWC callback, only the first time of emulation of SB from TA may be bound to the “slow path” and all later emulations may be optimized via the “fast path” (i.e., once TB is generated following the first time SB is reached and the PVM has inserted the mapping from TW to TB into translation indexing table).

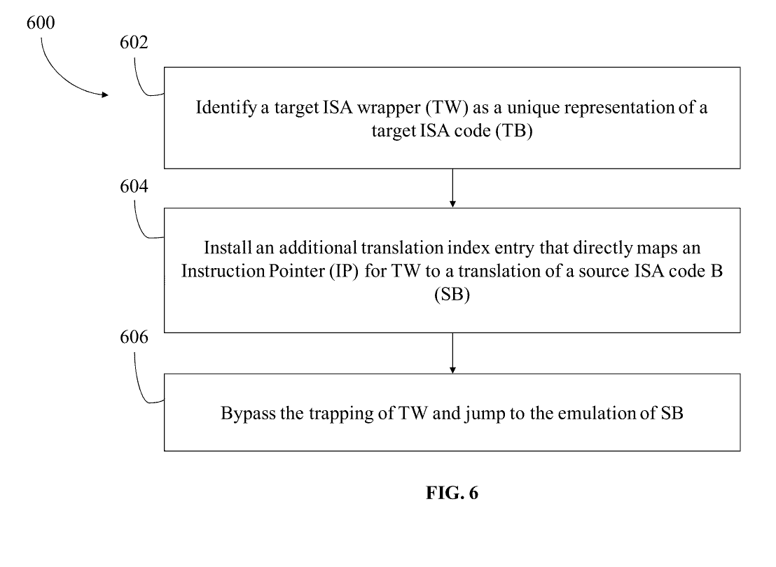

FIG. 6 is a flowchart of an example of a method for improving an emulated execution flow of a PWC callback function according to an embodiment. The improvement may be realized by removing a context switch from an executor to a PVM runtime to provide a more efficient path for PWC callback emulation. The method 600 may be implemented in executable software as a set of logic instructions stored in a machine- or computer-readable storage medium of a memory such as random access memory (RAM), read-only memory (ROM), programmable ROM (PROM), firmware, flash memory, etc., in configurable logic such as, for example programmable logic arrays (PLAs), field programmable gate arrays (FPGAs), complex programmable logic devices (CPLDs), in fixed functionality logic hardware using circuit technology such as, for example, application-specific integrated circuits (ASIC), complementary metal oxide semiconductor (CMOS) or transistor-transistor logic (TTL) technology, or any combination thereof. For example, computer program code to carry out operations shown in method 400 may be written in any combination of one or more programming languages including an object-oriented programming language such as Java, Smalltalk, C++ or the like, and conventional procedural programming languages, such as the “C” programming language or similar programming languages.

Illustrated processing block 602 provides for identifying a target ISA wrapper (TW) as a unique representation of a target ISA code (TB). The translation may be performed, for example, via a translation lookup. Illustrated processing block 604 provides for installing a translation index entry that directly maps an Instruction Pointer (IP) for TW to a translation of a source ISA code B (SB). The translation entry may be performed, for example, by replacing the function pointer with the target ISA wrapper code. Illustrated processing block 606 provides for bypassing the trapping of TW and jumping to the emulation of SB. Jumping to the emulation of SB may be accomplished without breaking the emulation flow. The PVM may thereby improve efficiency by removing the context switch from the executor to the PVM runtime for PWC callback emulation.

An example of an optimized emulated execution flow for a PWC callback may be provided, as follows:

Data structure:
typedef struct {

int value;
int (*func)(int, int);

} Node_t;
A Node_t object may be created in source ISA, as follows:
// code in source ISA
Node_t *node = (Node_t*)malloc(sizeof(Node_t);
node−>func = foo; // foo is an function in source ISA
Later the node object may be passed to target ISA and called from target
ISA, as
// code in target ISA
node−>func(arg0, arg1)

In some binary translators, this may fail because it crosses the ISA boundary. In order to hide the source ISA function, the PVM may create a callback wrapper instead, as follows:

// wapper_of_foo will be in target ISA with the capability of
// trapping into PVM runtime when it was executed. It also
// encodes the address of foo within the wrapper, or in some
// table that the address of foo may be read from.
Node.func = wrapper_of_foo;

With the help of the wrapper_of_foo, the target ISA may call to the callback function foo which is emulated in PVM's ISA emulator.

However, another piece of code may also reference the node object and call to function foo:

// code in source ISA
node −>func(arg0, arg1)

As func′ is already pointed to the wrapper_of_foo, the PVM runtime has to identify the callback wrapper during the ISA emulation, and decodes/looks-up the address of foo from the wrapper_of_foo, and then decides the next source IP.

### Additional Notes and Examples

Example 1 may include a pseudo-wrapped callback (PWC) apparatus for improving an emulated execution flow of a PWC callback function. The apparatus may be implemented at least partially in a source instruction set architecture. The apparatus may include a processor and memory arrangement, and a processor virtual machine including an instruction set architecture emulator and a process virtual machine runtime. The instruction set architecture emulator may be configured to at least partially maintain an execution context of a source instruction set architecture. The process virtual machine runtime may be in communication with the instruction set architecture emulator to at least partially maintain an execution of a target instruction set architecture library. The process virtual machine may also be configured to bypass the trapping of a target wrapper and proceed to an emulation of the source instruction set architecture code.

Example 2 may include the system of example 1, wherein the process virtual machine further includes an instruction set architecture bridging loader configured to load an application.

Example 3 may include the system of any of one examples 1 or 2, wherein the instruction set architecture emulator includes a translator configured to translate source instruction set architecture instructions into target instruction set architecture instructions.

Example 4 may include the system of example 3, wherein the instruction set architecture emulator further includes a translation manager configured to facilitate emulation of the source instruction set architecture instructions.

Example 5 may include the system of example 4, wherein the translation manager further includes a translation index table and a translation pool, wherein each translation in the translation pool is to be indexed in the translation index table by IP address of a block of source instruction set architecture instructions.

Example 6 may include the system of example 3, wherein the process virtual machine further includes an executor configured to retrieve and execute a translation with a given IP address of source instruction set instructions to perform a translation lookup, or when no translation is associated with the IP address, trigger the translator to generate a new translation.

Example 7 may include the system of example 1, wherein the process virtual machine runtime further includes a library context, gates configured to correspond to a wrapper function, and wrapper functions configured to correspond to library services, callback functions, and overriding implementations of virtual functions of target library services.

Example 8 may include a pseudo-wrapped callback (PWC) method for improving an emulated execution flow of a PWC callback function. The method may be implemented at least partially in a source instruction set architecture. The method may be configured to maintain an execution context of a source instruction set architecture, and maintain an execution of a target instruction set architecture library, bypassing the trapping of a target wrapper. The method may also be configured to proceed to the emulation of a source instruction set architecture code. The method may be executed via an instruction set architecture emulator and a process virtual machine runtime in communication with the instruction set architecture emulator.

Example 9 may include the method of example 8, wherein the process virtual machine further includes an instruction set architecture bridging loader configured to load an application.

Example 10 may include the method of any one of examples 8 or 9, further including translating, via a translator in communication with the instruction set architecture emulator, source instruction set architecture instructions into target instruction set architecture instructions.

Example 11 may include the method of example 10, further including facilitating, via a translation manager in communication with the instruction set architecture emulator, execution of the source instruction set architecture instructions.

Example 12 may include the method of example 11, further including indexing, via a translation manager and a translation pool in communication with the translation manager, each translation in the translation pool into the translation index table by entry address.

Example 13 may include the method of example 10, further including retrieving and executing, via an executor in communication with the process virtual machine, a translation with a given IP address to perform a translation lookup, or triggering, via the executor, when no translation is associated with the executor, the translator to generate a new translation.

Example 14 may include the method of example 8, wherein the process virtual machine runtime further includes a library context, gates configured to correspond to a wrapper function, and wrapper functions configured to correspond to library services, call functions, and overriding implementations of virtual functions of target library services.

Example 15 may include at least one non-transitory computer readable storage medium including a set of instructions which, if executed by a processor, cause a computer to maintain an execution context of a source instruction set architecture, maintain an execution of a target instruction set architecture library, bypass a trapping of a target wrapper; and proceed to an emulation of the source instruction set architecture code.

Example 16 may include the medium of example 15, further including a set of instructions which, if executed by a processor, further cause a computer to load an application.

Example 17 may include the medium of any one of examples 15 or 16, further including a set of instructions which, if executed by a processor, further cause a computer to translate source instruction set architecture instructions into target instruction set architecture instructions.

Example 18 may include the medium of example 17, further including a set of instructions which, if executed by a processor, further cause a computer to facilitate emulation of the source instruction set architecture instructions.

Example 19 may include the medium of example 18, further including a set of instructions which, if executed by a processor, further cause a computer to index each translation in a translation pool into a translation index table by IP address of a block of source instruction set instruction.

Example 20 may include the medium of example 17, further including a set of instructions which, if executed by a processor, further cause a computer to retrieve and execute a translation with a given IP address to perform a translation lookup, or trigger, when no translation is associated with the executor, the translator to generate a new translation.

Example 21 may include the medium of example 15, further including a set of instruction which, if executed by a processor, further cause a computer to provide a library context, provide gates corresponding to a wrapper function, and provide wrapper functions corresponding to library services, call functions, and overriding implementations of virtual functions of target library services.

Example 22 may include a pseudo-wrapped callback (PWC) apparatus for improving an emulated execution flow of a PWC callback function. The apparatus may be implemented at least partially in a source instruction set architecture. The apparatus may include means for maintaining an execution context of a source instruction set architecture, means for maintaining an execution of a target instruction set architecture library, and means for bypassing the trapping of a target wrapper. The apparatus may also include means for proceeding to the emulation of a source instruction set architecture code.

Example 23 may include the apparatus of example 22, wherein the process virtual machine further includes an instruction set architecture bridging loader configured to load an application.

Example 24 may include the apparatus of any one of claim 22 or 23, further including translating, via a translator in communication with the instruction set architecture emulator, source instruction set architecture instructions into target instruction set architecture instructions.

Example 25 may include the apparatus of example 24, further including facilitating, via a translation manager in communication with the instruction set architecture emulator, execution of the source instruction set architecture instructions.

Example 26 may include the apparatus of example 25, further including indexing, via a translation manager and a translation pool in communication with the translation manager, each translation in the translation pool into the translation index table by entry address.

Example 27 may include the apparatus of example The apparatus of claim 24, further including retrieving and executing, via an executor in communication with the process virtual machine, a translation with a given IP address to perform a translation lookup, or triggering, via the executor, when no translation is associated with the executor, the translator to generate a new translation.

Example 28 may include the apparatus of example 22, wherein the process virtual machine runtime further includes a library context, gates configured to correspond to a wrapper function; and wrapper functions configured to correspond to library services, call functions, and overriding implementations of virtual functions of target library services.

Various embodiments may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

One or more aspects of at least one embodiment may be implemented by representative instructions stored on a non-transitory machine-readable storage medium which represents various logic within the processor, which when read by a machine causes the machine to fabricate logic to perform the techniques described herein. Such representations, known as “IP cores” may be stored on a tangible, non-transitory, machine readable storage medium and supplied to various customers or manufacturing facilities to load into the fabrication machines that actually make the logic or processor.

Embodiments are applicable for use with all types of semiconductor integrated circuit (“IC”) chips. Examples of these IC chips include but are not limited to processors, controllers, chipset components, programmable logic arrays (PLAs), memory chips, network chips, and the like. In addition, in some of the drawings, signal conductor lines are represented with lines. Some may be different, to indicate more constituent signal paths, have a number label, to indicate a number of constituent signal paths, and/or have arrows at one or more ends, to indicate primary information flow direction. This, however, should not be construed in a limiting manner. Rather, such added detail may be used in connection with one or more exemplary embodiments to facilitate easier understanding of a circuit. Any represented signal lines, whether or not having additional information, may actually comprise one or more signals that may travel in multiple directions and may be implemented with any suitable type of signal scheme, e.g., digital or analog lines implemented with differential pairs, optical fiber lines, and/or single-ended lines.

Example sizes/models/values/ranges may have been given, although embodiments are not limited to the same. As manufacturing techniques (e.g., photolithography) mature over time, it is expected that devices of smaller size could be manufactured. In addition, well-known power/ground connections to IC chips and other components may or may not be shown within the figures, for simplicity of illustration and discussion, and so as not to obscure certain aspects of the embodiments. Further, arrangements may be shown in block diagram form in order to avoid obscuring embodiments, and also in view of the fact that specifics with respect to implementation of such block diagram arrangements are highly dependent upon the platform within which the embodiment is to be implemented, i.e., such specifics should be well within purview of one skilled in the art. Where specific details (e.g., circuits) are set forth in order to describe example embodiments, it should be apparent to one skilled in the art that embodiments may be practiced without, or with variation of, these specific details. The description is thus to be regarded as illustrative instead of limiting.

Some embodiments may be implemented, for example, using a machine or tangible computer-readable storage medium or article which may store an instruction or a set of instructions that, if executed by a machine, may cause the machine to perform a method and/or operations in accordance with the embodiments. Such a machine may include, for example, any suitable processing platform, computing platform, computing device, processing device, computing system, processing system, computer, processor, or the like, and may be implemented using any suitable combination of hardware and/or software. The machine-readable storage medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions may include any suitable type of code, such as source code, compiled code, interpreted code, executable code, static code, dynamic code, encrypted code, and the like, implemented using any suitable high-level, low-level, object-oriented, visual, compiled and/or interpreted programming language.

Unless specifically stated otherwise, it may be appreciated that terms such as “processing,” “computing,” “calculating,” “determining,” or the like, refer to the action and/or processes of a computer or computing system, or similar electronic computing device, that manipulates and/or transforms data represented as physical quantities (e.g., electronic) within the computing system's registers and/or memories into other data similarly represented as physical quantities within the computing system's memories, registers or other such information storage, transmission or display devices. The embodiments are not limited in this context.

The term “coupled” may be used herein to refer to any type of relationship, direct or indirect, between the components in question, and may apply to electrical, mechanical, fluid, optical, electromagnetic, electromechanical or other connections. In addition, the terms “first”, “second”, etc. may be used herein only to facilitate discussion, and carry no particular temporal or chronological significance unless otherwise indicated.

Those skilled in the art will appreciate from the foregoing description that the broad techniques of the embodiments may be implemented in a variety of forms. Therefore, while the embodiments of this have been described in connection with particular examples thereof, the true scope of the embodiments should not be so limited since other modifications will become apparent to the skilled practitioner upon a study of the drawings, specification, and following claims.

We claim:

1. An apparatus to execute an application implemented at least partially in a source instruction set architecture, the apparatus comprising:
a processor and memory arrangement having a target instruction set architecture; and
a process virtual machine including:
an instruction set architecture emulator configured to at least partially maintain an execution context of a source instruction set architecture, and
a process virtual machine runtime, in communication with the instruction set architecture emulator, to at least partially maintain an execution of a target instruction set architecture library, wherein the process virtual machine is configured to bypass a trapping of a target wrapper and proceed to an emulation of the source instruction set architecture code.

2. The apparatus of claim 1, wherein the process virtual machine further includes an instruction set architecture bridging loader configured to load an application.

3. The apparatus of claim 1, wherein the instruction set architecture emulator includes a translator configured to translate source instruction set architecture instructions into target instruction set architecture instructions.

4. The apparatus of claim 3, wherein the instruction set architecture emulator further includes a translation manager configured to facilitate emulation of the source instruction set architecture instructions.

5. The apparatus of claim 4, wherein the translation manager further includes a translation index table and a translation pool, wherein each translation in the translation pool is to be indexed in the translation index table by IP address of a block of source instruction set architecture instructions.

6. The apparatus of claim 3, wherein the process virtual machine further includes an executor configured to:
retrieve and execute a translation with a given IP address of source instruction set instructions to perform a translation lookup; or,
when no translation is associated with the IP address, trigger the translator to generate a new translation.

7. The apparatus of claim 1, wherein the process virtual machine runtime further includes:
a library context,
gates configured to correspond to a wrapper function; and
wrapper functions configured to correspond to library services, callback functions, and overriding implementations of virtual functions of target library services.

8. A method comprising:
maintaining, via an instruction set architecture emulator, an execution context of a source instruction set architecture;
maintaining, via a process virtual machine runtime in communication with the instruction set architecture emulator, an execution of a target instruction set architecture library;
bypassing, via a process virtual machine including the instruction set architecture and the virtual machine runtime, a trapping of a target wrapper; and
proceeding, via the process virtual machine, to an emulation of the source instruction set architecture code.

9. The method of claim 8, wherein the process virtual machine further includes an instruction set architecture bridging loader configured to load an application.

10. The method of claim 8, further comprising translating, via a translator in communication with the instruction set architecture emulator, source instruction set architecture instructions into target instruction set architecture instructions.

11. The method of claim 10, further comprising facilitating, via a translation manager in communication with the instruction set architecture emulator, execution of the source instruction set architecture instructions.

12. The method of claim 11, further comprising indexing, via a translation manager and a translation pool in communication with the translation manager, each translation in the translation pool into the translation index table by entry address.

13. The method of claim 10, further comprising:
retrieving and executing, via an executor in communication with the process virtual machine, a translation with a given IP address to perform a translation lookup; or,
triggering, via the executor, when no translation is associated with the executor, the translator to generate a new translation.

14. The method of claim 8, wherein the process virtual machine runtime further includes:
a library context,
gates configured to correspond to a wrapper function; and
wrapper functions configured to correspond to library services, call functions, and overriding implementations of virtual functions of target library services.

15. At least one non-transitory computer readable storage medium comprising a set of instructions which, if executed by a processor, cause a computer to:
maintain an execution context of a source instruction set architecture;
maintain an execution of a target instruction set architecture library;
bypass a trapping of a target wrapper; and
proceed to an emulation of the source instruction set architecture code.

16. The medium of claim 15, further comprising a set of instructions which, if executed by a processor, further cause a computer to load an application.

17. The medium of claim 15, further comprising a set of instructions which, if executed by a processor, further cause a computer to translate source instruction set architecture instructions into target instruction set architecture instructions.

18. The medium of claim 17, further comprising a set of instructions which, if executed by a processor, further cause a computer to facilitate emulation of the source instruction set architecture instructions.

19. The medium of claim 18, further comprising a set of instructions which, if executed by a processor, further cause a computer to index each translation in a translation pool into a translation index table by IP address of a block of source instruction set instruction.

20. The medium of claim 17, further comprising a set of instructions which, if executed by a processor, further cause a computer to:
retrieve and execute a translation with a given IP address to perform a translation lookup; or,
trigger, when no translation is associated with the executor, the translator to generate a new translation.

21. The medium of claim 15, further comprising a set of instruction which, if executed by a processor, further cause a computer to:
provide a library context,
provide gates corresponding to a wrapper function; and
provide wrapper functions corresponding to library services, call functions, and overriding implementations of virtual functions of target library services.
